(19) United States
(12) Patent Application Publication
(10) Pub. No.: US 2014/0072226 A1
(43) Pub. Date: Mar. 13, 2014

(54) Searching and Sorting Image Files

(71) Applicants: Barry A. Kritt, Research Triangle Park, NC (US); Sarbajit K. Rakshit, Kolkata (IN)

(72) Inventors: Barry A. Kritt, Research Triangle Park, NC (US); Sarbajit K. Rakshit, Kolkata (IN)

(73) Assignee: INTERNATIONAL BUSINESS MACHINES CORPORATION, Armonk, NY (US)

(21) Appl. No.: 13/613,217

(22) Filed: Sep. 13, 2012

(51) Int. Cl. G06K 9/68; G06K 9/46

(52) U.S. Cl. 382/190; 382/218

(57) ABSTRACT

Organization of electronic images. Objects within an image are identified by analyzing search results responsive to a search employing search criteria and at least one image associated with the objects to be identified. Images are sorted responsive to the identified objects and sort criteria related to the identified objects. Images containing identified objects, including sorted images, are presented.

### BACKGROUND

### Technical Field

The present invention relates to a method and computer program product for image analysis. More specifically, the invention relates to a system and method that identifies image objects and matches identified objects to images for sorting.

### Description of the Prior Art

Digital photography and the storage of digital images has become commonplace. With many image libraries containing a very large number of stored images, there exists a need to efficiently filter through unwanted images, as well as search for, and identify images of interest. Images are currently identified through search mechanisms by their associated metadata or local data containing recorded information about the image, such as recorded global positioning coordinates of an image. Through search means, it is possible to identify specific images in an image set without having to manually sift through the images individually.

This search mechanism however, is fairly limiting. Images containing limited metadata are often unidentifiable considering only features recorded in the metadata can be searched. Further issues arrive when a specific object in an image containing multiple unwanted objects is desired to be searched.

### SUMMARY OF THE INVENTION

A method and computer program product for matching objects and query results to images for identification and sorting.

In one aspect, a method is provided for sorting images. A first result set responsive to entry of a first set of search criteria is returned. The search criteria comprising at least one attribute related to an image file taken from a set of images in a data storage device in communication with a processing unit. The first result set is compared with each image file for matching the search criteria. The sort criteria is applied to the first result set. More specifically, the image set for an object match within a matching image is dynamically searched, wherein the matching image matches the search criteria and the sort criteria. The image files are sorted based on the object match. The sorted image file matches are presented with each image match in the sorted image files containing at least one object matching the search criteria. Accordingly, search criteria are used to sort images depicting matching objects.

In another aspect, a method is provided for identifying objects within an image file. Responsive to entry of search criteria and one or more image files, one or more objects within a set of at least one image file is dynamically searched. More specifically, one or more objects within a set of at least one image file matching user selected criteria regarding an attribute of the one or more objects is dynamically searched. One or more objects of interest are identified in at least one of the image files satisfying the search criteria. Each matching image file is presented. More specifically, an identified object within the matching image file is presented. Accordingly, search criteria are used to identify objects of interest in an image.

In yet another aspect, a computer program product for use with electronic image data is provided. The computer program product includes a computer readable non-transitory storage medium having computer readable program code embodied thereon, which when executed causes a computer to implement a method for sorting electronic image data. The computer program product returns a first result set responsive to entry of a first set of search criteria comprising at least one attribute related to an image file taken from a set of images in a data storage device, the data storage device in communication with a processing unit. The computer program product compares the first result set with the image files for matching the search criteria. Sort criteria are then applied to the first result set. More specifically, the computer program product dynamically searches the image set for an object match within a matching image, wherein the matching image matches the search criteria and the sort criteria. The computer program product sorts the image files based on the object match, and presents the sorted image file matches on a visual display, wherein each image match in the sorted image files contains at least one object matching the search criteria. Accordingly, the computer program product sorts electronic image data in response to search criteria regarding object identification.

In an even further aspect, a computer program product for use with an electronic image is provided. The computer program product includes a computer readable non-transitory storage medium having computer readable program code embodied thereon, which when executed causes a computer to implement a method for identification of one or more objects in an image. The computer program product, responsive to entry of search criteria and one or more image files, dynamically searches for one or more objects within the at least one image file in a data storage device in communication with a processing unit matching user selected criteria regarding an attribute of the objects. The computer program product identifies one or more objects of interest in at least one of the image files satisfying the search criteria. The computer program product presents each matching image file. More specifically, the computer program product portrays an identified object within the matching image file. Accordingly, the computer program product identifies one or more objects within an image responsive to search criteria and one or more image files.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flow chart illustrating a method for sorting images based on sort criteria results.

FIG. 2 is a block diagram of an embodiment of the invention for a search and sort mechanism for images.

FIG. 3 is a flow chart illustrating a method to identify objects in an image.

FIG. 4 is a block diagram of an embodiment of the invention for an image with identified objects.

FIG. 5 is a flow chart illustrating a method to search for matching images.

FIG. 6 is a block diagram for a system for object identification and sorting of stored image data.

FIG. 7 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processing units. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

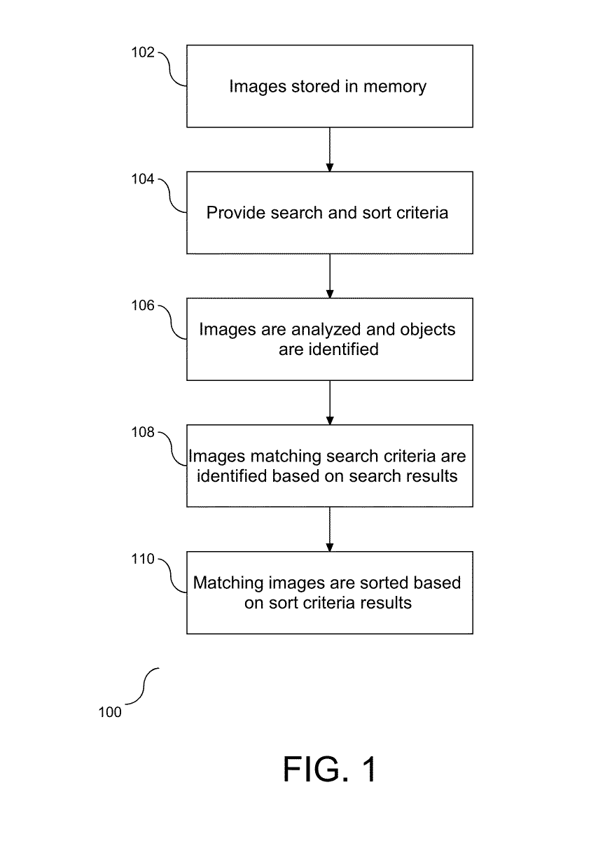

FIG. 1 is a flow chart (100) for sorting images based on search and sort criteria. Initially, a set of images is stored in memory (102), e.g. local or remote data storage. At a given time, an image, or a set of images, may be requested containing specific criteria. In one embodiment, specifics pertaining to the criteria are not readily apparent, identifiable, or in the metadata of the image. Search criteria are provided (104). In one embodiment, this search criterion includes: an image containing objects, an image containing metadata, criteria in the form of textual attributes describing an object, and/or criteria in the form of textual specifications. Results of the search are identified and gathered. Accordingly, the search criteria support input in the form of images and/or textual descriptions.

The set of stored images are analyzed (106). More specifically, objects within an image are autonomously identified. Images matching the search criteria are identified based on the search results (108). An image is considered to be matching if the metadata for an image matches the search results or if one or more identified objects within at least one image matches a search result. In one embodiment, an object is considered to match a search result if there is an inputted image in the search criteria and the object in the image containing the matching object is the same object as an object in an image input as search criteria. If the search criteria include a textual description, then the object may also fit the textual description in order to be considered matching. In one embodiment, the query employs the use of logical operators which will determine inclusive or exclusive conjunction of image objects and textual description. Any matching images are sorted based on the sort criteria results (108). In one embodiment, the matching images are sorted by grouping images that are considered matching and images that are considered to be not matching. In another embodiment, sorting criteria is input and the images are sorted and/or ordered based on the input sorting criteria. Accordingly, images are identified as matches and are sorted based on objects matching search criteria results.

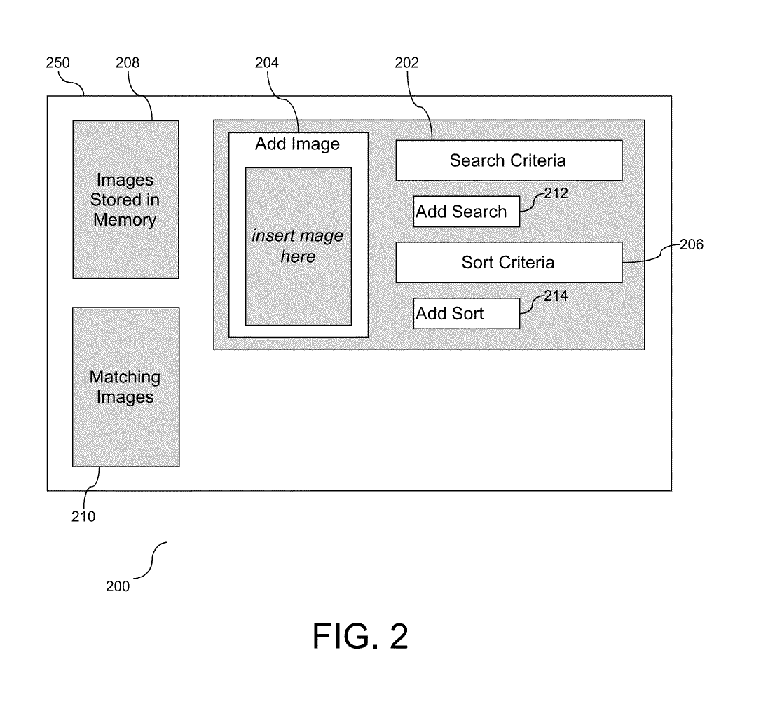

FIG. 2 is a block diagram (200) illustrating a searching and sorting interface. Areas of input are shown on a visual display (250), including an area to input search criteria (202), an area to upload and input an image (204), and an area to input sorting criteria (206). In one embodiment, an area to add additional search criteria and sort criteria is provided (212) and (214), respectively. Similarly, in one embodiment, a field may be provided within the interface to upload image metadata. As shown, an area is provided to display the images stored in memory to be analyzed (208). In another embodiment, an area is provided to display images considered to be matching (210). The interface (200) is an example and should not be considered limiting. Accordingly, an interface to input various search and sort criteria is provided.

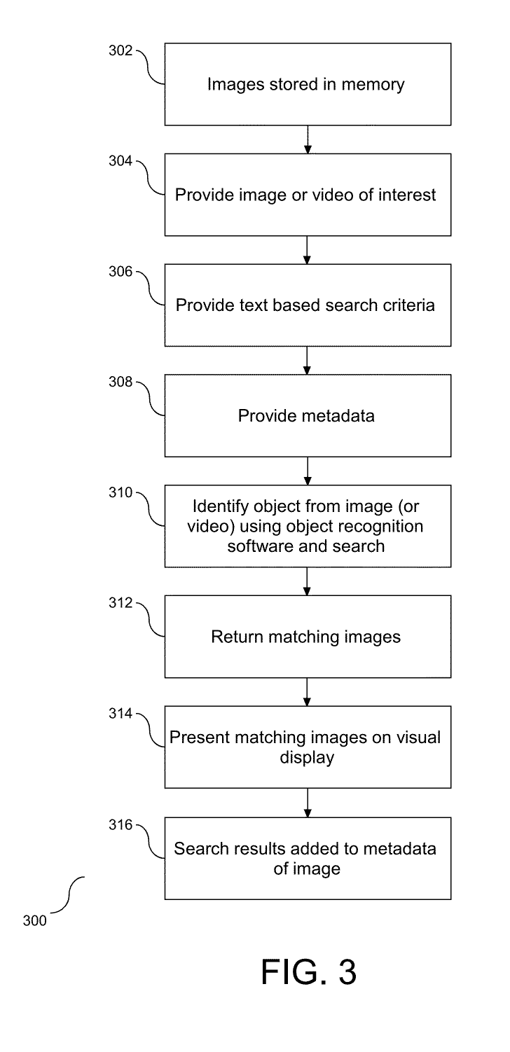

FIG. 3 is a flow chart (300) illustrating a method for searching for images containing specific objects. Images or video are stored in local or remote data storage (302). An image or video of interest containing an object of interest serves as input (304). Text based search criteria is also provided to limit the search of the images or video for target objects (306). In one embodiment, metadata is employed as input (408). For example, GPS coordinates of an input image may be used as metadata input. Search results are gathered and objects contained within the input image or video are identified (310). In one embodiment, the objects are identified through the use of image recognition software and/or a query sent to a remote server. In one embodiment, the text based name of the identified object is visually displayed with the image. In another embodiment, the text based name of the identified object is added to the metadata of the input image. Matching images in the form of images containing identified objects matching the search criteria are returned (312). The matching images are presented on a visual display (314) and in one embodiment, are presented on the visual display such that the identified objects matching the search criteria are highlighted. In one embodiment, relevant search results are added to the metadata of matching images (316). In another embodiment, the stored images are sorted, including separating matching and non-matching images. Accordingly, objects matching search criteria in an image or video are identified and displayed.

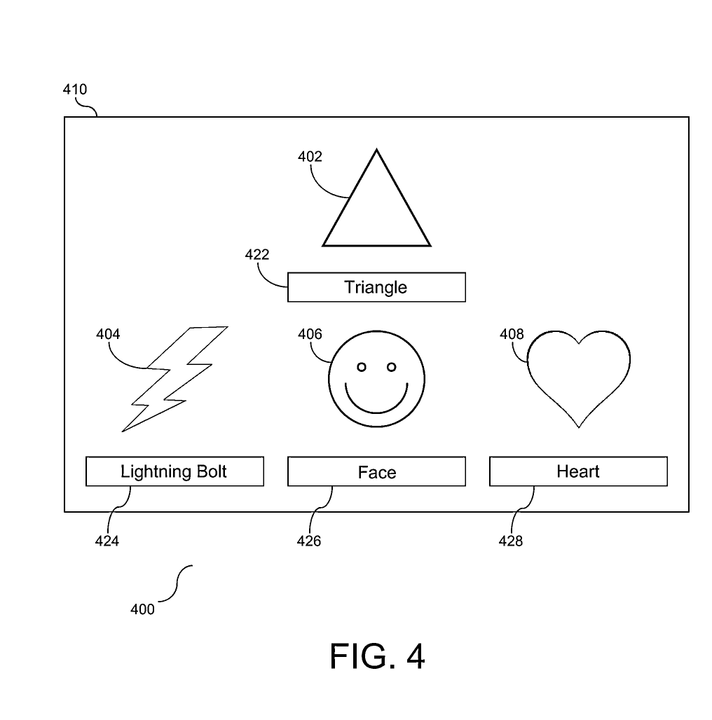

FIG. 4 is a block diagram (400) depicting an image containing objects to be identified. An image can contain multiple objects and in this example four objects are identified (402)-(408). In one embodiment the search results are overlaid in the image as labels (422)-(428) upon display. All objects are analyzed through a search and in this example objects (404) and (408) are considered to match the search criteria. The image (410) is determined to be a matching image because the image contains at least one object matching the search criteria and objects (404) and (408) are highlighted upon display. In one embodiment, the search criteria contains multiple objects requirements and an image is considered matching only when all object requirements are identified within the image. Accordingly, a visual display is provided to highlight and display matching objects in a matching image.

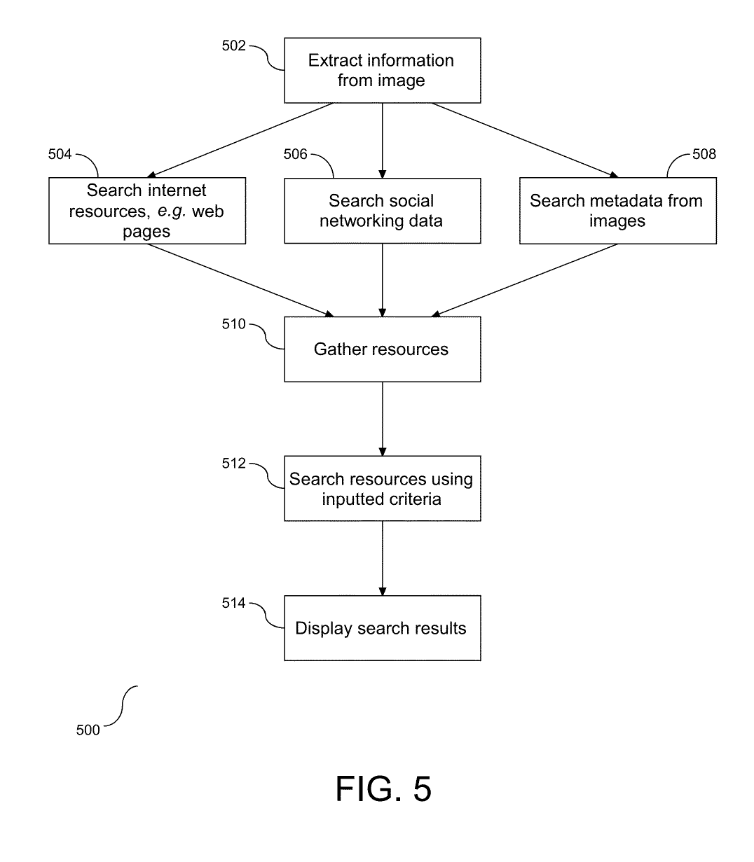

FIG. 5 is a flow chart (500) illustrating the search process for image identification. Upon inputting search criteria which may include an image and/or text based specifications, information associated with the image is extracted (502) and a search is conducted in a variety of areas. In one embodiment, the information extracted from the image may include but is not limited to: location based coordinates e.g. global positioning coordinates associated with the image, metadata attached to the image, and/or recognized objects in the image e.g. historical patterns of any physical object. Any extracted information, in combination with any inputted search criteria including text based specifications, is used to conduct the search. Various sources are searched including but not limited to, web site resources available in different servers (504), social networking site data (506), and/or metadata associated with physical objects in images found over the remote server (508). All relevant resources are gathered (510). The resources are searched using the inputted search criteria (512). In one embodiment, any search results found are displayed (514). In one embodiment, the search results are displayed as an overlay with the inputted image or in one embodiment, an image stored in data storage. Accordingly, a variety of sources are searched to identify relevant information associated with an image.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processing unit of a general purpose computer, special purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

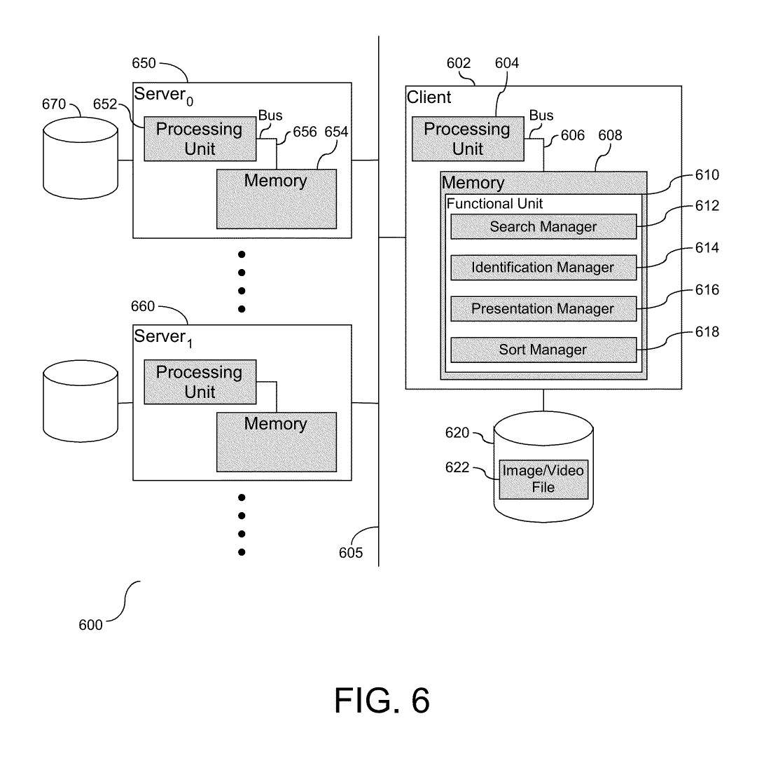

FIG. 6 is a system (600) for identification and sorting of stored image data. A client (602) in communication with data storage (620) containing image data (622) is provided having a processing unit (604) in communication with memory (608) across a bus (606). The client further comprises of a functional unit (610) having tools embedded therewith. The tools include but are not limited to, a search manager (612), an identification manager (614), and a presentation manager (616). In one embodiment, a sort manager (618) is also included in the tools of the functional unit (610).

The search manager, in communication with at least one server (650) across a network (605) responds to input of search criteria comprising at least one attribute related to an object in an image file taken from the image data (622) by returning a first result set. While two servers are shown, (650) and (660) respectively, any number of servers may be employed across the network (605). The server (650) includes a processing unit (652) in communication with memory (654) across a Bus (656) and is in communication with data storage (670). The identification manager (614) identifies one or more objects of interest in image files that satisfy the search criteria. The presentation manager (616) presents the image files satisfying the search criteria. In one embodiment, a sort manager (618) responds to sort criteria by sorting the set of images that match the search criteria. The presentation manager (616) then presents the sorted images sorted by the sort manager (618).

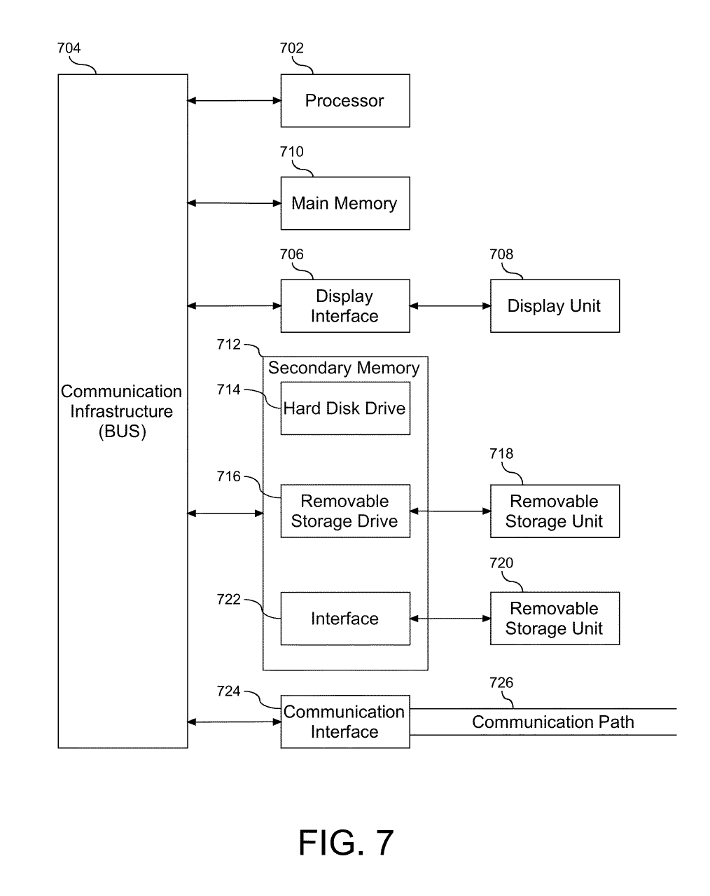

Referring now to the block diagram of FIG. 7, additional details are now described with respect to implementing an embodiment of the present invention. The computer system includes one or more processors, such as a processor (702). The processor (702) is connected to a communication infrastructure (704) (e.g., a communications bus, cross-over bar, or network).

The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712).

The secondary memory (712) may include, for example, a hard disk drive (714) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by removable storage drive (716). As will be appreciated, the removable storage unit (718) includes a computer readable medium having stored therein computer software and/or data.

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) are in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the enhanced cloud computing model supports flexibility with respect to clustering of data, including, but not limited to, deriving one or more communities for the data and dynamic formation or re-formation of one or more communities in response to receipt of the new data.

### Alternative Embodiment

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A computer program product for use with a set of images for sorting, the computer program product comprising:
a computer readable non-transitory storage medium having computer readable program code embodied therewith, which when executed causes a computer to:
return a first result set responsive to entry of a first set of search criteria comprising at least one attribute related to an image file taken from a set of images in a data storage device in communication with a processing unit,
compare the first result set with the image files for matching the search criteria;
apply sort criteria to the first result set, including the computer to dynamically search the image set for an object match within a matching image, wherein the matching image matches the search criteria and the sort criteria;
sort the image files based on the object match; and
present the sorted image file matches on a visual display, wherein each image match in the sorted image files contains at least one object matching the search criteria.

14. The computer program product of claim 13, further comprising the computer program product to identify text data for each object match, the text data matching the search criteria.

15. The computer program product of claim 14, further comprising the computer program product to apply indicia to the object match within the matching image, the applied indicia to highlight the matching object within the image.

16. The computer program product of claim 13, wherein the first set of search criteria further comprises at least one image.

17. The computer program product of claim 13, further comprising the computer program product to sort the matching images responsive to the search criteria.

18. The computer program product of claim 13, further comprising the computer program product to autonomously add metadata to the sorted images, the metadata comprising information acquired from the first result set.

19. A computer program product for use with at least one image for object identification, the computer program product comprising:
a computer readable non-transitory storage medium having computer readable program code embodied thereon, which when executed causes a computer to:
responsive to entry of search criteria and one or more image files, dynamically searching for one or more objects within a set of at least one image file in a data storage device in communication with a processing unit matching user selected criteria regarding an attribute of the objects; and
identifying one or more objects of interest in at least one of the image files satisfying the search criteria; and
presenting each matching image file, including portraying an identified object within the matching image file.

20. The computer program product of claim 19, wherein the search for the one or more objects includes the computer program product to extract one or more image objects from the entered image files and apply the search for each extracted object.

21. The computer program product of claim 20, further comprising the computer program product to apply a highlight to each matching image object in an image file.

22. The computer program product of claim 20, further comprising the computer program product to apply a secondary image to the extracted and matching image object as an overlay.

23. The computer program product of claim 19, further comprising the computer program product to autonomously conduct a search query upon identification of the object for information relevant to the object, and the computer program product to present filtered search query results on the visual display.

24. The computer program product of claim 23, further comprising the computer program product to attach the relevant information to the metadata of the image file containing the object.

25. (canceled)
